(19) United States
(12) Patent Application Publication
(10) Pub. No.: US 2008/0320137 A1
(43) Pub. Date: Dec. 25, 2008

(54) FIELD DEVICE

(75) Inventors: Kazuyuki ITO, Musashino-shi (JP); Takeshi Ohno, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 12/141,385

(22) Filed: Jun. 18, 2008

(30) Foreign Application Priority Data
Jun. 20, 2007 (JP) 2007-162677

(51) Int. Cl. G06F 15/173

(52) U.S. Cl. 709/225

(57) ABSTRACT

Disclosed is a field device which constitutes a plurality of distributed systems to perform a data communication with another field device on a network. The field device includes: an application execution section to execute a distributed application based on each distributed system; a storage section to store setting information on virtual communication addresses allocated to each field device constituting the plurality of distributed systems for each distributed system; and a control section to determine whether a requested data communication is in a same distributed system based on the stored setting information on the virtual communication addresses when the data communication is requested by the application execution section. If the data communication is in the same distributed system, the control section notifies a management section of a virtual communication address of a destination device, and requests the management section to perform the data communication with the destination device.

### BACKGROUND OF THE INVENTION

1. Field of the Invention

The present invention relates to a field device.

2. Description of Related Art

In recent years, various proposals have been made with respect to a distributed system constructed by various kinds of devices (hereinafter, “field devices”) on a field (for example, see Japanese Patent Application Laid-Open No. 2006-146420).

FIG. 9 shows a schematic diagram of field devices A to C constituting conventional distributed systems.

As shown in FIG. 9, a plurality of field devices A, B and C on a network constitute two distributed systems 1 and 2. Each of the field devices A to C includes one or more application elements (hereinafter, “AP elements”) each running a distributed application processing, and runs a target application in each of the distributed systems 1 and 2 by providing the other field devices A to C with a processing service of the AP elements and by getting the processing service from the other field devices A to C.

Unique device communication addresses (e.g., an IP address for a TCP/IP communication) are allocated to each of the field devices A to C. This enables an OS (Operating system) of each of the field devices A to C to identify the other field devices A to C, i.e., destination devices, based on the device communication addresses of the destination devices during a data communication. Therefore, according to a conventional technique, port numbers (e.g., port numbers or service numbers for the TCP/IP communication) are allocated to each AP element, and a combination of the device communication address and a port number indicating an AP element requesting for processing is designated to identify the field devices A to C and the AP element.

However, a requester that requests a processing may not be able to identify an AP element which is a target of request by the combination of the existing device communication address and the port number. This is because in the environment in which a plurality of distributed systems operate in parallel, a plurality of AP elements executing the same processing run on a single field device simultaneously. As a result, one port number that should uniquely identify one AP element is allocated to a plurality of AP elements. If one port number is allocated to a plurality of AP elements, a data communication cannot be held because of a conflict among the AP elements. The port number may be changed depending on the situation so as to avoid such a conflict. In this case, however, the port number of the destination device cannot be identified.

Moreover, an OS of each of the field devices A to C provides a communication processing in accordance with common communication specifications without discrimination between the distributed systems 1 and 2 during the data communication. Therefore, a network environment necessary for each of the distributed systems cannot be established independent of the other distributed system. That is, since the distributed systems use common communication functions of OS without discrimination between the distributed systems, the communication functions influence one another between the distributed systems.

### SUMMARY OF THE INVENTION

It is, therefore, a main object of the present invention to establish an independent distributed system and execute an application smoothly.

According to one aspect of the present invention, there is provided a field device constituting a plurality of distributed systems to perform a data communication with another field device on a network, the field device including: an application execution section to execute a distributed application processing based on each of the distributed systems; a storage section to store setting information on virtual communication addresses allocated to each of a plurality of field devices constituting the plurality of distributed systems for each of the distributed systems; a control section to determine whether a requested data communication is in a same distributed system based on the stored setting information on the virtual communication addresses when the data communication is requested by the application execution section, and to permit the data communication, and to notify a management section of a virtual communication address of a destination device, and to request the management section to perform the data communication with the destination device if the data communication is in the same distributed system; and the management section to perform the data communication with the destination device using the notified virtual communication address.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic diagram showing a plurality of field devices constituting distributed systems according to preferred embodiments of the present invention;

FIG. 2 is a block diagram showing a main configuration of each of the field devices;

FIG. 3 is a schematic diagram showing functions of an information processing apparatus and the respective field devices;

FIG. 4 shows an example of a management table;

FIG. 5 is a flowchart explaining a processing executed when setting each of the field devices;

FIG. 6 is a schematic diagram showing communication channels established for each distributed system among the field devices;

FIG. 7 is a flowchart explaining a processing executed during a data communication between the field devices;

FIG. 8 is an example of a management table according to another embodiments of the present invention; and

FIG. 9 is a schematic diagram showing field devices constituting conventional distributed systems.

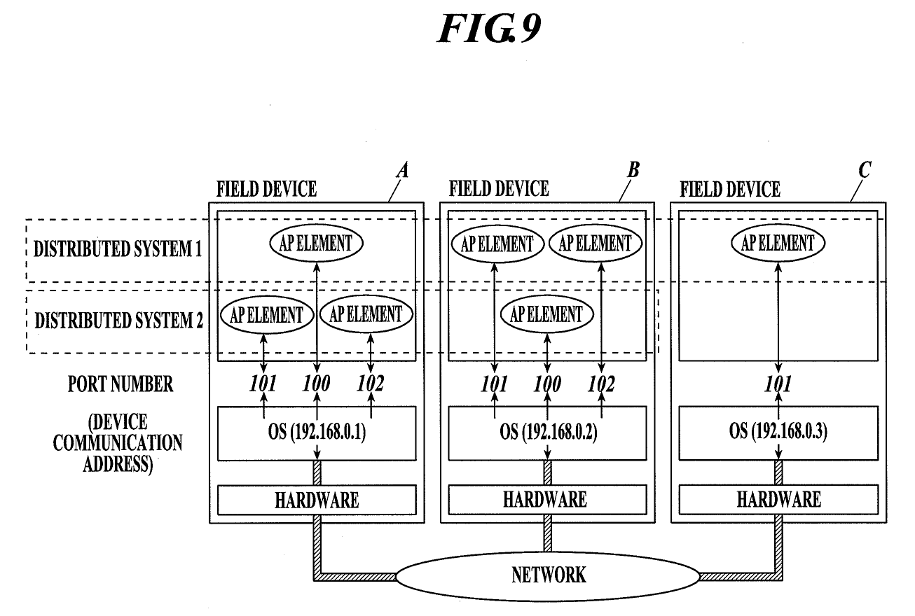

### DESCRIPTION OF THE PREFERRED EMBODIMENTS

Preferred embodiments of the present invention will be explained with reference to the drawings.

First, a configuration of the embodiments of the present invention will be described.

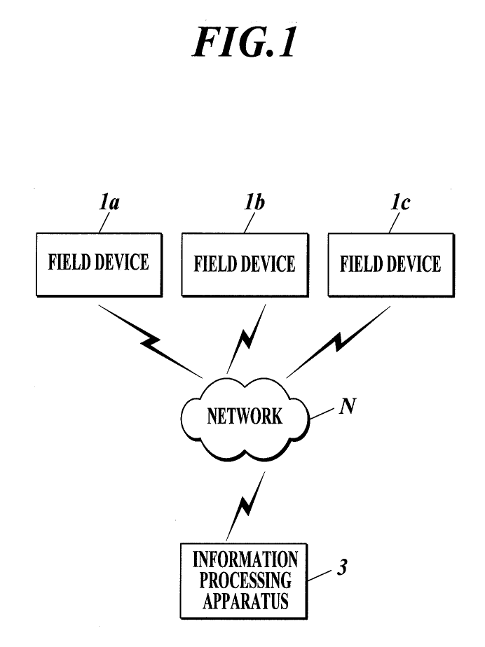

FIG. 1 shows field devices 1a to 1c according to the embodiments. While the three field devices 1a to 1c are shown in FIG. 1, the number of field devices is not limited to three.

As shown in FIG. 1, the field devices 1a to 1c are interconnected through a network N. The field devices 1a to 1c establish one or more distributed systems and execute an intended application in each distributed system by providing processing services among the field devices 1a to 1c.

Furthermore, as shown in FIG. 1, the respective field devices 1a to 1c are connected to an information processing apparatus 3 via the network N. The information processing apparatus 3 is intended to set the field devices 1a to 1c, respectively. The information processing apparatus 3 is an ordinary computer device such as a personal computer (PC) or a personal digital assistant (PDA) including a control section, a display section, an operating section, a storage section, a communication section, etc. Instead of providing the information processing apparatus 3 separately from the field devices 1a to 1c, the setting function of the information processing apparatus 3 may be incorporated in one of the field devices 1a to 1c.

Examples of the network N include a local area network (LAN) and a wide area network (WAN) constructed by a public line, a telephone line, a wireless communication line, an optical communication line, etc.

Each of the field devices 1a to 1c is a network device such as a sensor, an actuator, a controller, a communication measuring device, a measurement device, an integrated circuit (IC) tester, a camera, a router or a switch.

A configuration of each of the field devices 1a to 1c will be described. Since the respective field devices 1a to 1c are identical in basic configuration, the configuration of the field device 1a will be typically described.

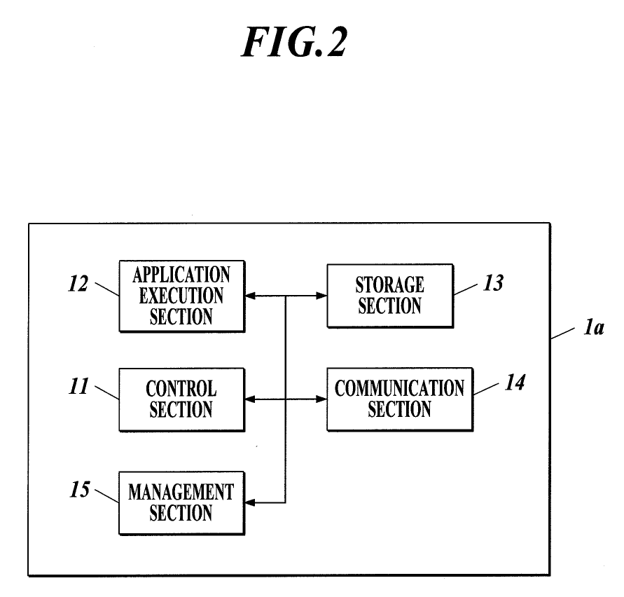

FIG. 2 shows a block diagram of a main configuration of the field device 1a.

As shown in FIG. 2, the field device 1a is configured to include a control section 11, an application execution section 12, a storage section 13, a communication section 14, and a management section 15. The field device 1a may further include another functional section (such as a sensor functional section if the field device 1a is a sensor or a camera functional section if the field device 1a is a camera) necessary for each of the field devices 1a to 1c.

The control section 11 controls the application execution section 12, the management section 15 and the like by cooperation with a central processing unit (CPU), a memory or the like and middleware software stored in the storage section 13, thereby executing a middleware function.

The application execution section 12 performs various calculations and executes a distributed application processing (a processing corresponding to a part of an application) by cooperation with the CPU, the memory or the like and application software stored in the storage section 13, thereby executing a function of an AP element.

The management section 15 executes an OS function by cooperation with the CPU, the memory or the like and software of OS stored in the storage section 13. To be more precise, the management section 15 executes a processing common to AP elements such as a communication processing as well as implements memory management for storage section 13 and resource management such as allocation of hardware resources.

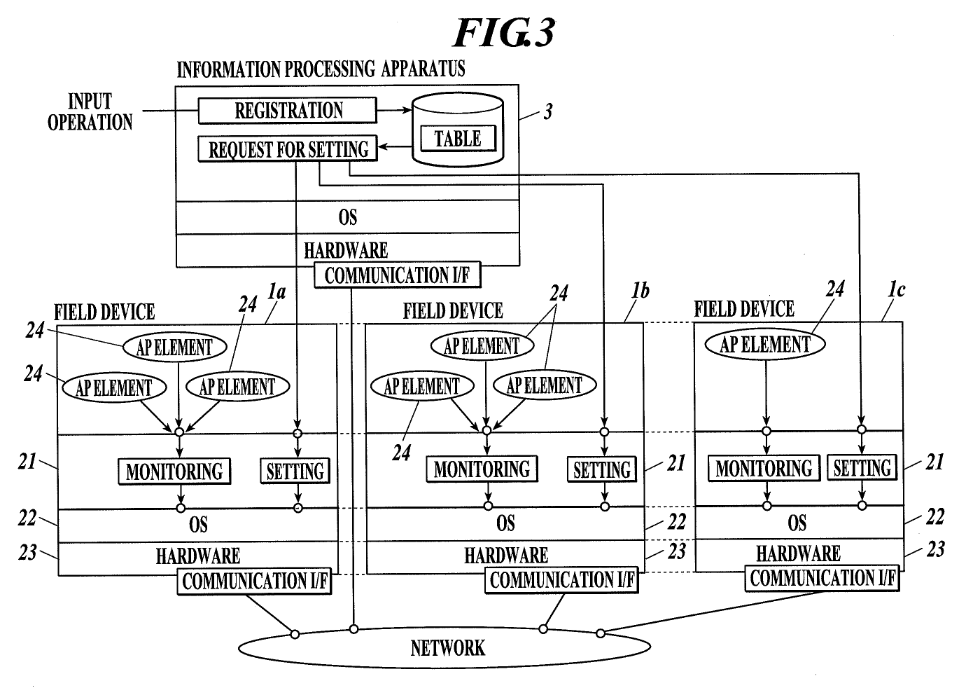

FIG. 3 is a schematic diagram showing functions executed by the control section 11, the application execution section 12, and the management section 15.

As shown in FIG. 3, in each of the field devices 1a to 1c, middleware 21 is provided between AP elements 24 and an OS 22 and controls an operation during a data communication. As described above, the function of the middleware 21 is executed by the control section 11. The OS 22 of one field device performs resource allocation of hardware 23 and performs a communication with the other field devices in accordance with one or more requests from one or more AP elements 24. The function of the OS 22 is executed by the management section 15. Various pieces of hardware 23 such as a communication I/F and a sensor operate under control of the OS 22. Each of the field devices 1a to 1c includes one or more AP elements 24. One application is executed by performing a data communication between the AP element 24 of one field device and the AP elements 24 of the other field devices and by providing processing services for each other. The function of the AP element 24 is executed by the application execution section 12.

The storage section 13 includes a hard disk, a memory or the like. The storage section 13 stores software such as the middleware, the OS and the application software, and stores parameters and the like.

The storage section 13 also stores a management table 131. The management table 131 is used for managing distributed systems.

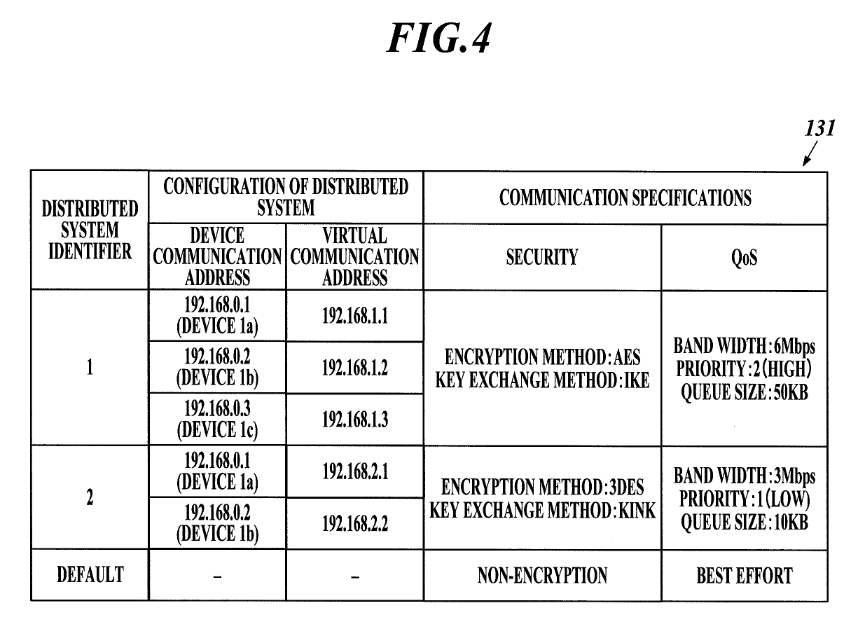

FIG. 4 shows an example of the management table 131.

As shown in FIG. 4, setting information on device communication addresses and virtual communication addresses and setting information on communication specifications defined for each of the distributed systems are registered in the management table 131 so as to correspond to information on identifiers (e.g., IDs such as “1” or “2”) assigned to each distributed system.

The device communication address is a communication address for uniquely identifying each of the field devices 1a to 1c and is, for example, an IP address in case of a TCP/IP protocol. The virtual communication address is an address for identifying a data communication between the field devices 1a to 1c for each of the distributed systems. The virtual communication addresses are allocated to each of the field devices 1a to 1c separately from the device communication addresses and are used solely for a data communication between the respective AP elements 24 in the same distributed system.

The communication specifications are defined for each distributed system and include setting information on security and QoS. The setting information on security includes an encryption method of data, a key exchange method, and an authentication method of a destination device (including a notification procedure of authentication information). The setting information on QoS includes a band width used for a communication, a communication delay and a jitter thereof, priorities (indicated by numbers 1, 2 in the order of ascending priorities) of a communication processing among the distributed systems, and a communication data loss ratio. The items of the setting information on the communication specifications are not limited to those mentioned above but other setting information intended to be common to each distributed system may be registered as items of the setting information. Examples of the other setting information include setting information on a frequency band if the distributed system is used on a wireless network.

For example, FIG. 4 shows that in a distributed system identified by an identifier 1, virtual communication addresses “192.168.1.1”, “192.168.1.2”, and “192.168.1.3” are set to the field devices 1a to 1c to which device communication addresses “192.168.0.1”, “192.168.0.2”, and “192.168.0.3” are allocated, respectively. In a distributed system identified by an identifier 2, virtual communication addresses “192.168.2.1” and “192.168.2.2” are set to the field devices 1a and 1b, respectively.

In the distributed system identified by the identifier 1, an encryption method “AES” and a key exchange method “IKE” are defined as security, and a band width “6 Mbps”, a priority “2”, and a queue size “50 KB” are defined as QoS. Communication specifications of the distributed system identified by the identifier 2 (For example, an encryption method “3DES” and a key exchange method “KINK” are defined as security) are different from that of the distributed system identified by the identifier 1.

Setting information on default communication specifications is also registered in the management table 131. The default communication specifications are adopted if the OS 22 does not support communication functions defined for each distributed system. For example, FIG. 4 shows that security “Non-encryption” and Qos “Best Effort” are defined as the default communication specifications.

The communication section 14 includes a communication interface (I/F), and communicates with another field devices 1b and 1c and the information processing apparatus 3 in accordance with the management section 15.

Next, an operation of the embodiments will be described.

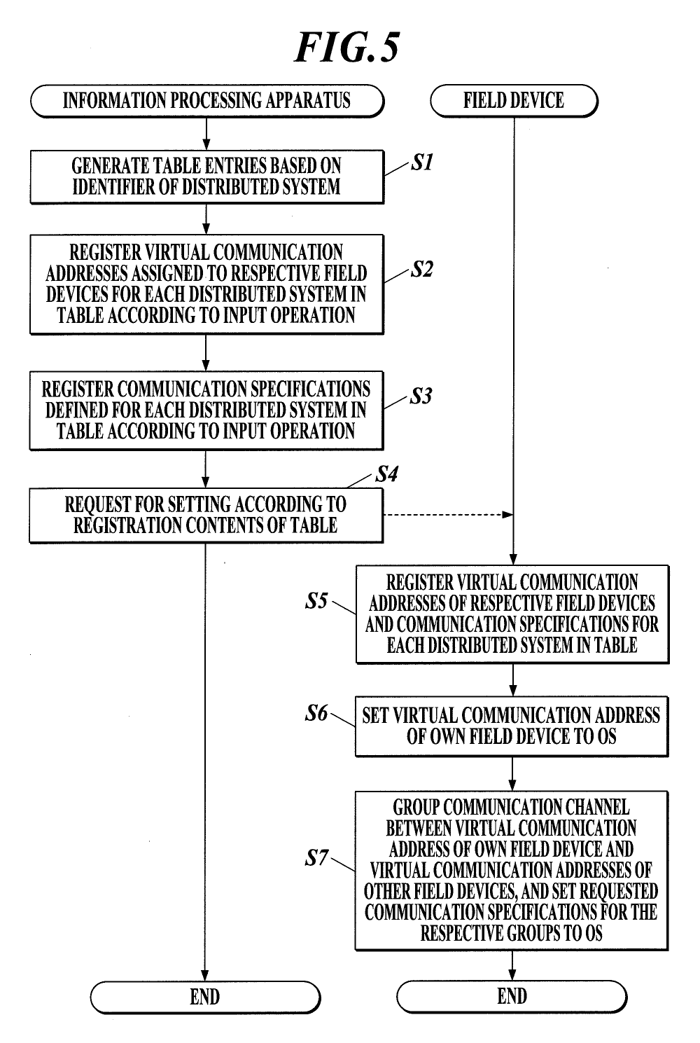

Each of the field devices 1a to 1c needs to set a virtual communication address via the information processing apparatus 3 prior to a data communication. Processing performed during the setting will be described with reference to FIGS. 3 and 5. FIG. 3 is a schematic diagram showing functions of the information processing apparatus 3 and the field devices 1a to 1c during the setting. FIG. 5 is a flowchart of a processing flow.

As shown in FIG. 5, the information processing apparatus 3 allocates identifiers to the distributed systems in accordance with the number of the distributed systems to be established, and generates table entries based on the identifiers (step S1). The table is identical in configuration to the management table 131 described above. That is, the table is configured to register setting information on the device communication addresses, the virtual communication addresses, and communication specifications with respect to each of the field devices 1a to 1c for each distributed system. An operator performs an input operation through an operating section (not shown) of the information processing apparatus 3 for inputting the setting information on device communication addresses of the respective field devices in each distributed system, the setting information on virtual communication addresses of the respective field devices 1a to 1c assigned for each distributed system, and the setting information on communication specification defined for each distributed system

The information processing apparatus 3 registers (writes) the inputted setting information on the communication addresses and the virtual communication addresses corresponding to the identifiers of the distributed systems in the table in accordance with the input operation (step S2). The information processing apparatus 3 further registers the setting information on the communication specifications in the table in accordance with the input operation (step S3).

After the registration is finished, the information processing apparatus 3 transmits information on the table and request information for requesting the respective field devices 1a to 1c to make setting in accordance with the contents of the registration in the table (step S4).

The middleware 21 in each of the field devices 1a to 1c writes and registers various items of setting information in the management table 131 based on the information on the table transmitted from the information processing apparatus 3 (step S5). The middleware 21 sets the virtual communication address with respect to its own field device based on the management table 131 (step S6). Specifically, the middleware 21 requests the OS 22 to set the virtual communication address, and the OS 22 sets the virtual communication address with respect to its own field device in response to the request from the middleware 21. For example, if the OS 22 is Linux, the OS 22 sets a VIP (Virtual IP) address as the virtual communication address using a netconf command.

Next, the middleware 21 groups communication channels between the set virtual communication address of the own field device and the virtual communication addresses of the other field devices. The middleware 21 requests the OS 22 to set communication specifications required for each grouped communication channel based on the setting information on the communication specifications in the management table 131. The OS 22 sets the communication specifications in response to the request (step S7). As for communication channels other than those of the distributed systems registered in the management table 131, the OS 22 sets default communication specifications.

An example of setting the communication specifications for a distributed system identified by an identifier 1 with respect to the field device 1a in accordance with the management table 131 shown in FIG. 4 will be specifically described. In this example, a communication channel between the virtual communication addresses “192.168.1.1” and “192.168.1.2” and a communication channel between the virtual communication addresses “192.168.1.1” and “192.168.1.3” in the distributed system identified by the identifier 1 are grouped, respectively. Then the setting information on security defined for the grouped communication channels, i.e., the encryption method “AES” and the key exchange method “IKE” are made available to the OS 22. For example, if the OS22 is Linux, racoon is used. Further, the communication band “6 Mbps” that is a part of a physical band of the network is secured for the grouped communication channels based on the setting information on QoS. For example, “iproute2 tc” may be used. With respect to a data communication in a communication channel other than these communication channels, since an available band in the communication is used without encryption according to the default setting, no special settings are required.

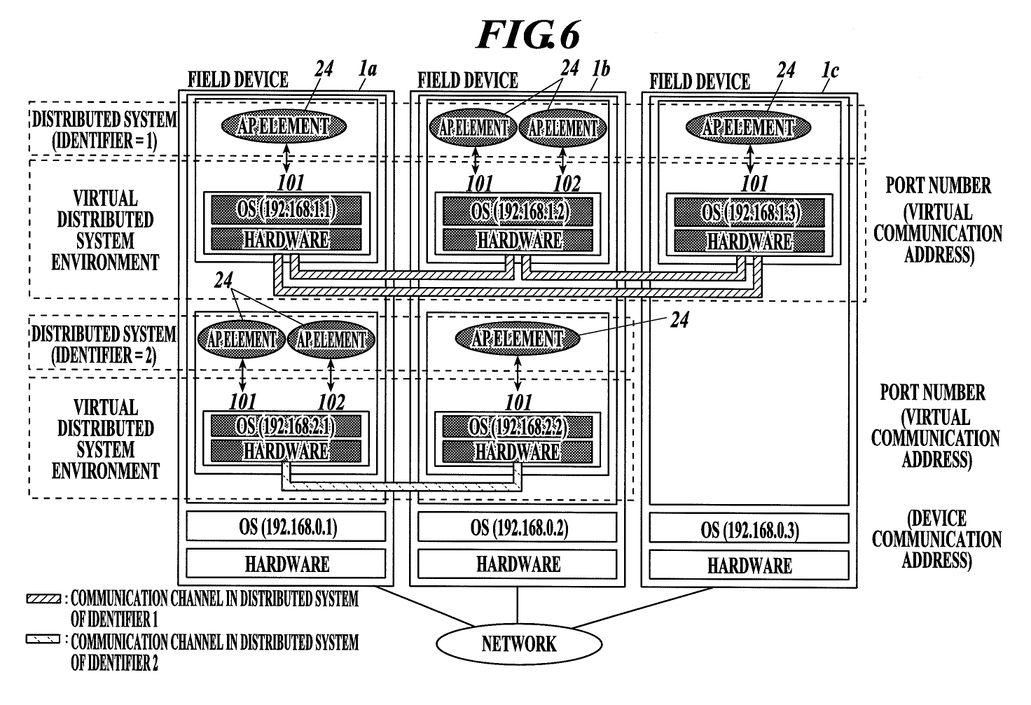

FIG. 6 is a schematic diagram of communication channels established among the field devices 1a to 1c as a result of the above-described settings.

As shown in FIG. 6, the virtual communication addresses are allocated to the field devices 1a to 1c for each of the distributed systems identified by the identifiers 1 and 2. The communication channels are established by grouping the virtual communication address of the field device 1a and those of the other field devices 1b and 1c in the same distributed system. As a result, the AP elements 24 in the field devices 1a to 1c are sorted for each distributed system, and it is possible to set environments in which the distributed systems are virtually independent of each other. In FIG. 6, shaded parts indicate virtual distributed system environments. By doing so, even if one port number is used for a plurality of AP elements 24 in a single field device, each of the AP elements 24 belonging to the respective distributed systems can be identified by the virtual communication addresses.

After the settings described above, data communications are available among the field devices 1a to 1c.

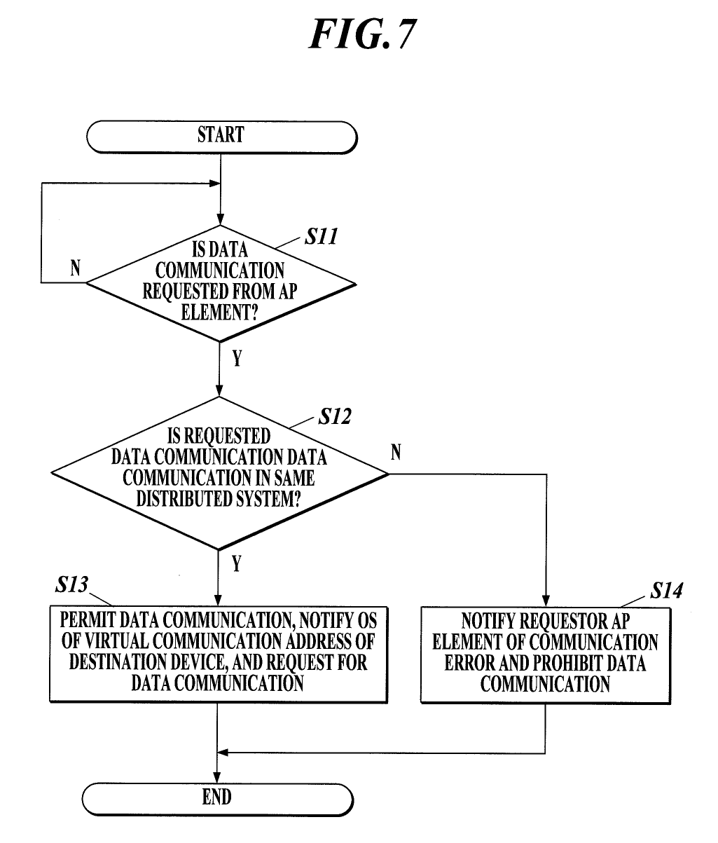

Referring to FIG. 7, a processing executed by each of the field devices 1a to 1c during a data communication will be described. While a processing executed by the field device 1a will be typically described below, the same processing can be executed by the other field devices 1b and 1c.

A data communication is classified into two types: a communication in which one field device transmits data to the other field devices to request a distributed application processing; and a communication in which a distributed application processing is requested from AP elements 24 in the other field devices. The former type of communication will be described below.

As shown in FIG. 7, an AP element 24 transmits request information on a data communication to the middleware 21 first. The request information includes information on data to be processed and a destination device (i.e., a virtual communication address corresponding to an AP element 24 which is to execute a distributed application processing).

If the request information on the data communication is inputted to the middleware 21 from the AP element 24 (step S11; Y), the middleware 21 extracts the virtual communication address designated as a destination device from the request information. Referring to the management table 131, the middleware 21 determines whether the requested data communication is in the same distributed system based on the virtual communication address of the requester AP element 24 and the extracted virtual communication address (step S12). For example, if the virtual communication address of the requester AP element 24 is “192.168.1.1” and the virtual communication address “192.168.1.2” is designated as the destination device, the both virtual communication addresses belong to the distributed system identified by the identifier 1 according to the management table 131 (see FIG. 4). Therefore, the middleware 121 determines that the requested data communication is in the same distributed system.

If the middleware 21 determines that the requested data communication is in the same distributed system (step S12; Y), the middleware 21 permits the requested data communication. Then the middleware 21 notifies the OS 22 of the virtual communication address of the requestor and the virtual communication address of the destination device, outputs the data to be processed, which is inputted from the requestor AP element 24, to the OS 22, and requests the data communication (step S13). In response to the request, the OS 22 transmits the input data to the notified virtual communication address. At this time, the OS 22 performs a data communication in accordance with the communication specifications defined for the communication channel between the notified virtual communication addresses of the requester and the destination device. In the above-described example, the OS 22 performs a data communication in accordance with the communication specifications defined for the communication channel between the virtual communication addresses “192.168.1.1” and “192.168.1.2”. In other words, the OS 22 performs data encryption based on the encryption method “AES”, and key exchange based on the key exchange method “IKE”. The total band of the two communication channels is 6 Mbps.

If the virtual communication address of the requester is “192.168.1.1” and the virtual communication address “192.168.2.2” is designated as a destination device, the virtual communication address of the requester belongs to a distributed system identified by an identifier 1 and the virtual communication address of the destination device belongs to a distributed system identified by an identifier 2. In this case, the middleware 21 determines that the requested data communication is not in the same distributed system. If the middleware 21 determines that the requested data communication is not in the same distributed system (step S12; N), the middleware 21 generates notification information on communication error, and outputs the notification information to the requestor AP element 24 to prohibit the data communication with the designated destination device (step S14).

As described above, according to the embodiments of the present invention, in addition to device communication addresses unique to field devices, unique virtual communication addresses are allocated to each field device for each distributed system. A communication channel is established between one AP element of one field device and another AP element of another field device using the virtual communication addresses. When communicating between AP elements 24, it is determined whether the requested data communication is in a same distributed system based on the virtual communication address of the requester and the virtual communication address of the destination device. If the requested data communication is in the same distributed system, the OS 22 is notified of the virtual communication address of the destination device to perform a data communication with the destination device. If the requested data communication is not in the same distributed system, the requester AP element 24 is notified of an error to prohibit the data communication. Because the data communication in each distributed system is monitored and the data communication between the different distributed systems is prevented, it is possible to establish the respective distributed systems independently and to execute an application smoothly. Furthermore, because the data communication between the different distributed systems is prohibited, it is possible to avoid an illegal access of one distributed system to another distributed system and an adverse influence (e.g., ping of death) caused by an unnecessary communication processing.

Moreover, even if the AP elements 24 having the same port number are executed on the same field device, the AP elements 24 can be identified for each distributed system by the virtual communication addresses. The embodiments are especially effective if well-known port numbers used in an ordinary Web service system are adopted because a data communication can be performed in the same distributed system without changing the port numbers.

Furthermore, the setting information on the communication specification defined for each distributed system is stored, and the OS 22 sets the communication specifications corresponding to the distributed system with respect to the communication channels established for each distributed system. It is thereby possible to perform a communication processing using the communication specifications corresponding to the distributed system when a data communication is performed. As a result, common communication specifications can be used in each distributed system and a network environment having communication specifications necessary for the distributed system can be constructed on a system-by-system basis. In other words, it is possible to construct network environments of the respective distributed systems independent of one another.

Further, the middleware 21, which is provided between the AP element 24 and the OS 22, monitors a data communication in each distributed system, and prohibits a data communication between different distributed systems. Therefore, there is no need to change design of the OS 22 and the AP elements 24 for independence of the network environments of the distributed systems and corresponding control of data communication. This is, conventional design can be used. Thus, it is possible to execute an application smoothly without extra cost.

### Another Embodiment

In the above-described embodiments, the example of using common communication specifications for each distributed system has been described. Furthermore, common system specifications can be used for each distributed system.

An embodiment of using the common system specifications for each distributed system will be described below.

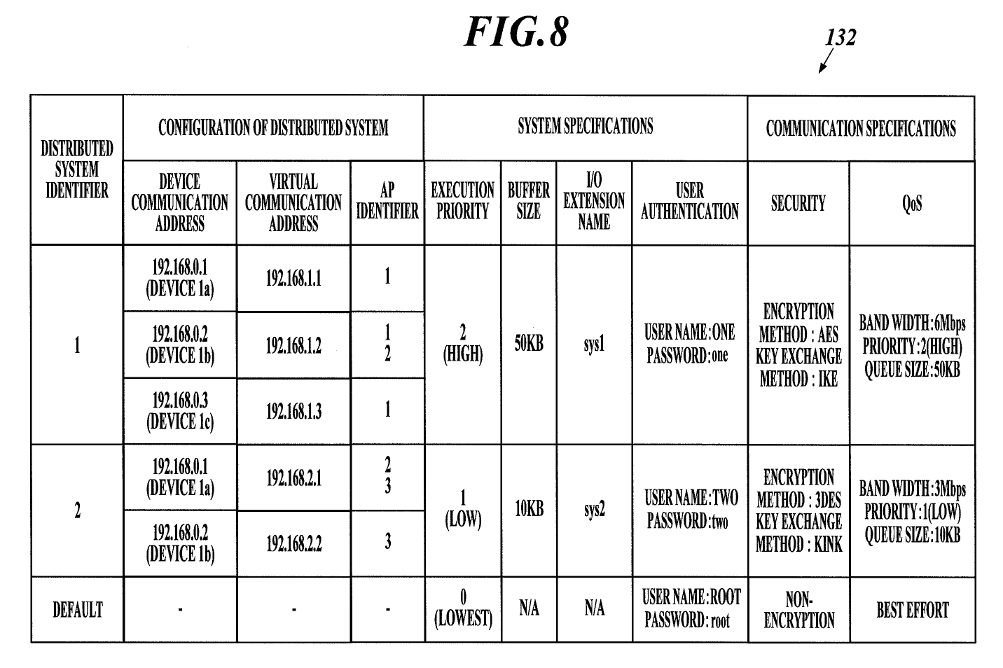

As with the above-described embodiments, it is only necessary to store setting information on system specifications defined for each distributed system in the storage sections 13 of each of the field devices 1a to 1c. FIG. 8 shows an example of a management table 132 storing the setting information on system specifications.

In addition to specifications for a distributed application processing by AP elements 24, the system specifications include specifications for management of hardware resources and user authentication performed by the OS 22 with respect to the distributed application processing.

As shown in FIG. 8, examples of the system specifications include an execution priority, a buffer size, an I/O extension name, and a user authentication. The execution priority indicates a priority of distributed application execution among the distributed systems. For example, the execution priority is expressed by numbers 0 (lowest priority) to 2 (high priority) in the order of ascending priority. The priority of a communication processing in the communication specifications of QoS may be defined in association with the execution priority.

The buffer size is an amount of data available in each distributed system and is defined as an amount of data available during an event if each of the AP elements 24 works in an event-driven manner. The transmission/reception queue size in the communication specifications of QoS may be defined in association with the buffer size. The I/O extension name is defined as a name space used in each distributed system. The respective distributed systems are different from one another in I/O extension name so as to avoid collision of I/O access names. The user authentication is defined as information for authenticating a permitted user with respect to execution of processing by each distributed system. Examples of the user authentication include a user name and a password.

Setting information on default system specifications is also registered in the management table 132. The default system specifications are adopted if the OS 22 does not support the system specifications defined for each distributed system. For example, FIG. 8 shows that an execution priority “0”, a buffer size “N/A”, an I/O extension name “N/A”, and a user name “ROOT” and a password “root” for user authentication are defined as the setting information on the default system specifications.

Furthermore, information on AP identifiers are also registered in the management table 132 so as to manage which AP element 24 in each of the field devices 1a to 1c belongs to which distributed system. The AP identifiers are allocated to each AP element 24 in each field device independently. For example, if the field device 1a has three AP elements 24 to which AP identifiers 1, 2, and 3 are allocated, respectively, and the AP element 24 identified by the AP identifier 1 belongs to a distributed system identified by an identifier 1, and the AP elements 24 identified by the AP identifiers 2 and 3 belong to a distributed system identified by an identifier 2, then information on the AP identifier 1 is registered corresponding to the distributed system identified by the identifier 1, and information on the AP identifiers 2 and 3 is registered corresponding to the distributed system identified by the identifier 2 as shown in FIG. 8.

A method of registering the setting information on the system specifications in the management table 132 is the same as the registration method described in the above-described embodiments. That is, the information processing apparatus 3 generates table entries and registers the setting information on the system specifications in accordance with input operation by an operator. The information processing apparatus 3 requests each of the field devices 1a to 1c to make settings based on registered contents. In each of the field devices 1a to 1c, the middleware 21 registers items of setting information on each of the distributed systems such as the virtual communication addresses, the system specifications, and the communication specifications in the management table 132. Further, the middleware 21 requests the OS 22 and the AP elements 24 to set the communication specifications and the system specifications for each of the grouped communication channels. This setting makes it possible to control the AP elements 24 and the OS 22 to operate under the communication specifications and the system specifications in accordance with each distributed system during an actual data communication.

For example, the execution priority is set by mapping an execution priority of each distributed system on an execution priority of the respective AP elements 24 managed by the OS 22. With respect to the buffer size, the OS 22 reserves a memory area of the buffer size in the storage section 13 so that the AP elements 24 can process the transmitted or received data. The I/O extension name is set by being mapped on a root directory for each user managed by the OS 22. When setting the user authentication, the OS 22 stores user information (such as a user name) and authentication information (such as a password) in association with each other in the storage section 13.

The middleware 21 monitors a data communication between the AP elements 24 and permits a data communication only if the data communication requested from the AP element 24 is in the same distributed system to cause the OS 22 to perform a communication processing. On the other hand, the middleware 21 prohibits a data communication if the data communication is not in the same distributed system. Since the user authentication is conducted during a data communication, the middleware 21 also prohibits the data communication even if the data communication is in the same distributed system if the user authentication fails. This enables the user authentication for each distributed system.

If the data communication is permitted, the OSs 22 and the AP elements 24 operate in accordance with the communication specifications and the system specifications defined for the distributed system when a data communication is performed between the AP elements 24. According to the management table 132 shown in FIG. 8, for example, since the distributed system identified by the identifier 1 is higher in execution priority than the distributed system identified by the identifier 2, the OS 22 of the field device 1a makes adjustments so that the AP element 24 (AP identifier 1) belonging to the distributed system identified by the identifier 1 can execute a distributed application processing preferentially over the AP elements 24 (AP identifiers 2 and 3) belonging to the distributed system identified by the identifier 2 even if all of these AP elements 24 are included in the same field device 1a.

Further, the AP element 24 of AP identifier 1 in the field device 1a adds a file extension “.sys1” to a file generated by the distributed application processing. Each of the AP elements 24 of AP identifiers 2 and 3 adds a file extension “.sys2” to a generated file even if the AP elements 24 of AP identifiers 2 and 3 are included in the same field device 1a as the AP element 24 of AP identifier 1. The file extension facilitates discrimination in which of the distributed system the file is generated.

Therefore, it is possible to use common communication specifications and common system specifications for each distributed system by making settings based on the management table 132.

As described above, according to another embodiment of the present invention, the setting information on the system specifications defined for each distributed system is further stored and each AP element 24 and each OS 22 set the system specifications in accordance with each distributed system. Thus, it is possible to operate the distributed system under the set system specifications. As a result, in addition to the advantage in the above-described embodiments, another embodiment of the present invention has the advantage of being able to execute a distributed application based on each distributed system. That is, it is possible to use common system specifications for each distributed system and to construct a system environment having system specifications necessary for the distributed system on a system-by-system basis.

Moreover, it is possible to manage operations of the AP elements 24 in each of the field devices 1a to 1c for each distributed system using the AP identifiers.

Another embodiment of the present invention is particularly effective if an event-driven function is necessary for a data communication between the AP elements 24. For example, like in a facility monitoring system, an added system function converts measurement values collected in a constant cycle into index values to display trends, and creates and notifies an alarm event as well as the index values if the index values exceed a threshold value. In this case, a highly reliable event-driven function can be realized by commonly using the AP elements 24, amounts of data processed during a communication processing in an event-driven manner (a buffer size), and execution priorities in each distributed system.

If the OS 22 is incapable of providing the communication specifications requested for each distributed system, the middleware 21 may provide a communication processing under the requested communication specifications in place of the OS 22. Further, in place of the middleware 21, the OS 22 may execute functions such as the setting of the virtual communication addresses, the communication specifications and the system specifications, and monitoring of data communication.

According to one aspect of the preferred embodiments of the present invention, there is provided a field device constituting a plurality of distributed systems to perform a data communication with another field device on a network, the field device including: an application execution section to execute a distributed application processing based on each of the distributed systems; a storage section to store setting information on virtual communication addresses allocated to each of a plurality of field devices constituting the plurality of distributed systems for each of the distributed systems; a control section to determine whether a requested data communication is in a same distributed system based on the stored setting information on the virtual communication addresses when the data communication is requested by the application execution section, and to permit the data communication, and to notify a management section of a virtual communication address of a destination device, and to request the management section to perform the data communication with the destination device if the data communication is in the same distributed system; and the management section to perform the data communication with the destination device using the notified virtual communication address.

Therefore, a requestor can identify the distributed application processing to be executed by a destination device using the virtual communication address for each distributed system. It is also possible to monitor a data communication and to perform the data communication only in the same distributed system. Therefore, it is possible to execute a application smoothly because the respective distributed systems can be dealt with as independent systems of one another.

Preferably, the storage section further stores setting information on communication specifications defined for each of the distributed systems, and if the control section determines that the requested data communication is in the same distributed system, the control section controls the management section to perform a communication processing in accordance with the communication specifications defined for the distributed system based on the stored setting information on the communication specifications.

Therefore, common communication specifications can be used in each distributed system and network environments having communication specifications necessary for each distributed system can be constructed. In other words, it is possible to construct network environments of the distributed systems independent of one another.

Preferably, the storage section further stores setting information on system specifications defined for each of the distributed systems, and if the control section determines that the requested data communication is in the same distributed system, the control section controls the application execution section and/or the management section to operate in accordance with system specifications defined for the distributed system based on the stored setting information on the system specifications.

Therefore, common system specifications can be used in each distributed system and system environments having system specifications necessary for each distributed system can be constructed. In other words, it is possible to construct system environments of the distributed systems independent of one another.

Preferably, if the control section determines that the requested data communication is not in the same distributed system, the control section prohibits the data communication.

Therefore, it is possible to prevent a data communication between different distributed systems, and to avoid an illegal access of one distributed system to another distributed system and an adverse influence (e.g., ping of death) caused by an unnecessary communication processing.

The entire disclosure of Japanese Patent Application No. 2007-162677 filed on Jun. 20, 2007 including specification, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A field device constituting a plurality of distributed systems to perform a data communication with another field device on a network, the field device comprising:
an application execution section to execute a distributed application processing based on each of the distributed systems;
a storage section to store setting information on virtual communication addresses allocated to each of a plurality of field devices constituting the plurality of distributed systems for each of the distributed systems;
a control section to determine whether a requested data communication is in a same distributed system based on the stored setting information on the virtual communication addresses when the data communication is requested by the application execution section, and to permit the data communication, and to notify a management section of a virtual communication address of a destination device, and to request the management section to perform the data communication with the destination device if the data communication is in the same distributed system; and
the management section to perform the data communication with the destination device using the notified virtual communication address.

2. The field device according to claim 1,
wherein the storage section further stores setting information on communication specifications defined for each of the distributed systems, and
if the control section determines that the requested data communication is in the same distributed system, the control section controls the management section to perform a communication processing in accordance with the communication specifications defined for the distributed system based on the stored setting information on the communication specifications.

3. The field device according to claim 1,
wherein the storage section further stores setting information on system specifications defined for each of the distributed systems, and
if the control section determines that the requested data communication is in the same distributed system, the control section controls the application execution section and/or the management section to operate in accordance with system specifications defined for the distributed system based on the stored setting information on the system specifications.

4. The field device according to claim 1,
wherein if the control section determines that the requested data communication is not in the same distributed system, the control section prohibits the data communication.
